(19) United States
(12) Patent Application Publication
(10) Pub. No.: US 2005/0060256 A1
(43) Pub. Date: Mar. 17, 2005

(54) Foreign exchange trading interface

(76) Inventors: Andrew Peterson, Weehawken, NJ (US); Lawrence Miller, New York, NY (US); Irene Eaglesfield, New York, NY (US); Suzanne Lesley Hubble, London (GB); Marc LeGelebart, New York, NY (US); Tamara Sablic, Brooklyn, NY (US); Robert Sagurton, Red Bank, NJ (US); Elena Theodorou, London (GB); WanHo Wah, Staten Island, NY (US); AiHua Zhou, Newark, NJ (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/884,111

(22) Filed: Jul. 2, 2004

Related U.S. Application Data
(60) Provisional application No. 60/502,586, filed on Sep. 12, 2003.

(51) Int. Cl. G06F 17/60

(52) U.S. Cl. 705/37

(57) ABSTRACT

A method for providing an interface for Foreign Exchange trading centered on an FX rate tile. The tile interface offers harmonized order and RFQ submission workflows. Users can also configure order and quote parameters by using input features of the tile display. The tile also serves as a flexible unit of display and order/quote creation. The tile can be resize, rearranged, torn off and joined into new windows. The above described features contribute to provide a unique harmonized, flexible, “tiled” foreign exchange trading interface.

### CROSS-REFERENCE TO RELATED APPLICATION

This application claims the benefit of U.S. Provisional Application No. 60/502,586, filed Sep. 12, 2003, the entire disclosure of which is hereby incorporated herein by reference.

### FIELD OF THE INVENTION

This invention relates to the field of human-machine interfaces, and, more particularly, to an interface for trading of currency and other financial instruments.

### BACKGROUND OF THE INVENTION

Ever since the advent of computerized trading, many different human-machine interfaces have been tried and discarded for many reasons. Some have been too difficult to use, some too difficult to understand at a glance, etc. A problem exists in the art that computerized trading interfaces, especially foreign exchange trading interfaces, do not provide integrated, clear yet flexible human-machine interaction.

### SUMMARY OF THE INVENTION

This problem is alleviated and a technical advance is achieved in the art by a method for providing an interface for Foreign Exchange (“FX”) trading. The singular nature of this interface is the FX rate tile. The tile interface offers harmonized order and request for quote (“RFQ”) submission workflows. Users can also configure order and quote parameters by using input features of the tile display. The tile also serves as a flexible unit of display and order/quote creation. The tile can be resized, rearranged, torn off and joined into new windows patterns. The above described features contribute to provide a unique harmonized, flexible, “tiled” foreign exchange trading interface.

### BRIEF DESCRIPTION OF THE DRAWINGS

A more complete understanding of this invention may be obtained from a consideration of this specification taken in conjunction with the drawings, in which:

FIG. 1 is an exemplary embodiment of a foreign exchange rate tile in accordance with an exemplary embodiment of this invention;

FIG. 2 is a flowchart of processing for execution of a left-click in accordance with an aspect of this invention;

FIG. 3 is a flowchart of processing for execution of a right-click in accordance with yet another aspect of this invention;

FIG. 4 is an illustration of dragging a foreign exchange tile of FIG. 1;

FIG. 5 is an illustration of rearranged foreign exchange tiles after dragging of FIG. 4;

FIG. 6 is an illustration of tearing-off a foreign exchange tile according to another aspect of this invention;

FIG. 7 is an illustration of dragging a foreign exchange tile tear-off to join an existing tear-off tile; and

FIG. 8 is an illustration of foreign exchange tiles joined after tear-off and joining as illustrated in FIG. 7; and

FIG. 9 is a block diagram of a computer platform on which the exemplary embodiment of this invention operates.

### DETAILED DESCRIPTION

The attributes of a new foreign exchange (“FX”) trading interface that this specification focuses on are:
The FX rate tile display unit;
Harmonized FX order and request for quote (“RFQ”) submission workflows;
Rearranging tile display units; and
Configuration of order/quote parameters from “tile” unit.

For the purposes of illustration and clarity, these qualities and workflows are described individually. However, such qualities and workflows should be considered as an integrated whole to realize the true value and singularity of our new FX trading interface.

An exemplary embodiment of this invention is described in connection with the JP Morgan Chase JPeX client. The JPeX client is the web based, Java applet developed and offered by JPMorganChase to internal and external clients as part of the JP Morgan eXpress™ platform. JP Morgan eXpress™ is JP Morgan's premier electronic trading platform across multiple asset classes and across multiple time zones. The platform provides a single point of access to JP Morgan's liquidity in major markets. Key functionality of the entire web client includes:
Continuous streaming prices on all Instruments;
Configurable trading default settings and user preferences; and
Straight through processing to settlement eliminating any manual intervention.

For securities trading major functionality includes:
Enhanced search function makes it easy to find the instruments you wish to monitor or trade;
Click and trade functionality with auto-acceptance to ensure execution times of less than two seconds;
Request for Quote functionality that allows the client to ask for different terms, for instance larger sizes than those quoted on screen or an irregular settlement date;
The option to leave subject orders at a particular level that are then subject to trader acceptance;
Automated hedge functionality when executing credit trades;
Multiple account trading—trades can be allocated to sub-accounts at trade inception;
Daily closing prices available; and
Advanced heat map research tools with integrated click and trade functionality.

For foreign exchange trading, key functionality includes:
Streaming Rates provided for Spot and Swaps;
Ability for user to select currency pairs and request a quote directly from a trader; and
Ability to trade Spot, Matched and Mismatched Swaps with standard tenors, Forward outrights, Forward Forwards, Pre-spot outrights, Broken dated swaps, Pre-spot swap.

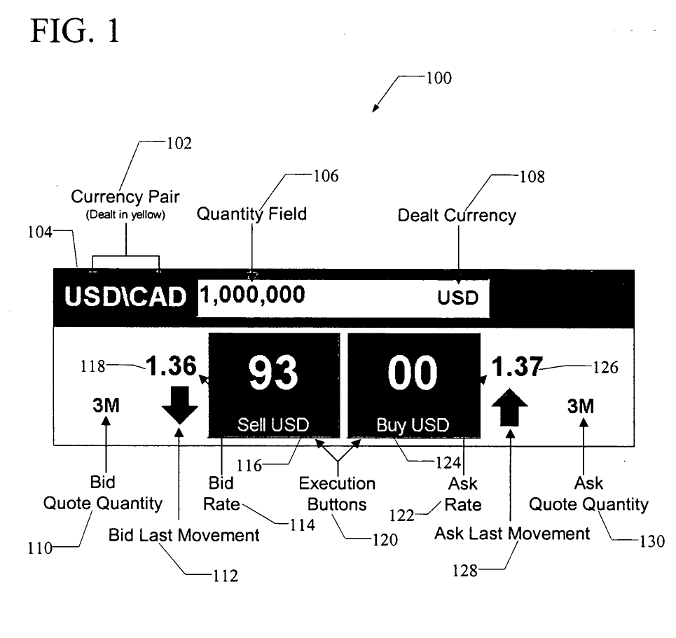

The foundation of the new FX trading interface is the “tile” display, as shown generally at 100 in FIG. 1. The components of the tile display are:
Currency Pair 102: This field display shows the currency pair shown in the tile. The currency, preferably displayed in yellow is the current dealt currency 104.
Quantity Field 106: This field allows the user to enter in the quantity for an order or quote.
Dealt Currency 108: This field displays the active dealt currency.
Bid Quote Quantity 110: This field shows the maximum quoted quantity allowable for immediate execution on the rate shown (114).
Bid Last Movement 112: This field shows the visual indication of the last price movement. A down arrow (preferably red) means the last movement was downward. An up arrow (preferably green) means the last movement was upward.
Bid Rate 114: The bid rate display 114 is split across two subfields. The larger display 116 shows the portion of the rate that is the focus for trading (i.e., the last two digits). The remainder of the rate is displayed to the side, at 118.
Execution Buttons 120: These buttons can be double clicked to initiate an order or quote to buy/sell the dealt currency.
Ask Rate 122: The ask rate display is split across two fields. The larger display 124 shows the portion of the rate that is the focus for trading (i.e. the last two digits). The remainder of the rate is displayed to the side, at 126.
Ask Last Movement 128: This field shows the visual indication of the last price movement. A down arrow (preferably red) means the last movement was downward. An up arrow (preferably green) means the last movement was upward.
Ask Quote Quantity 130: This field shows the maximum currently quoted quantity allowable for immediate execution on the rate shown (122).

One of the important and unique new features of this JPeX FX trading interface is that the rate tile 100 always serves as an entry point for simple, harmonized order and RFQ submission. It is important to note that this feature is always available, regardless of the positioning or rearrangement of the FX rate tiles as discussed further, below. The phrase “harmonized order and RFQ submission” is used to convey the fact that by using the same set of workflows, users of the new JPeX FX trading interface can easily initiate FX orders and RFQ'S.

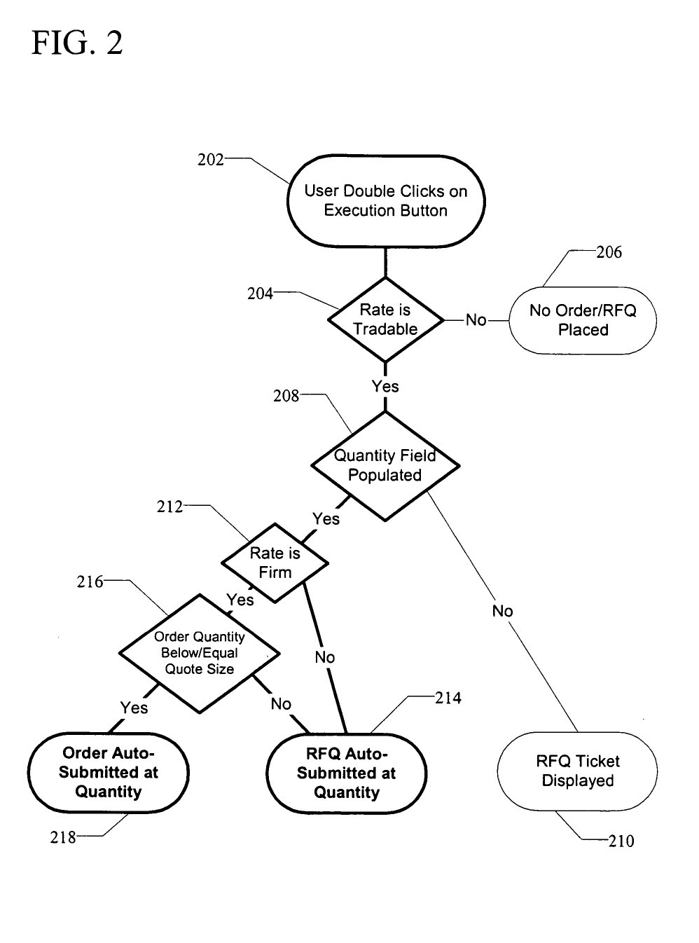

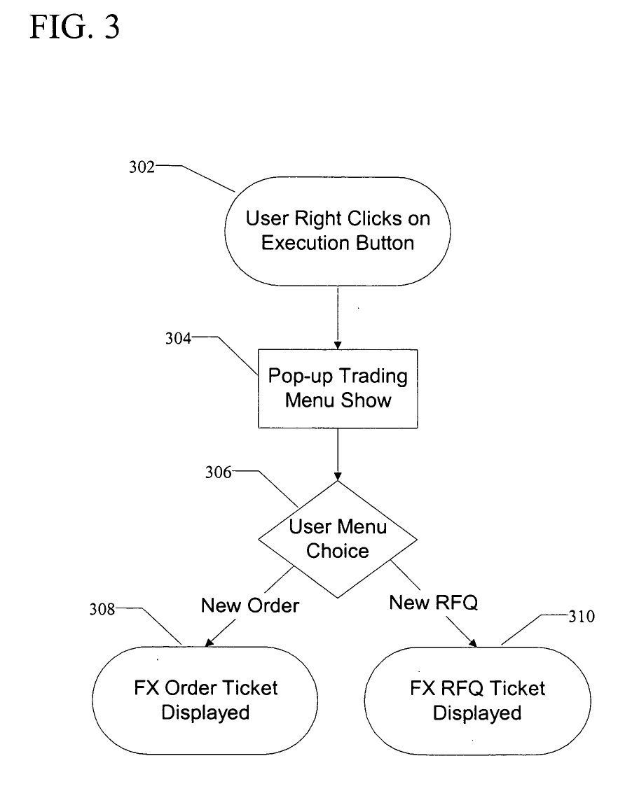

A further advantage of an FX trading tile 100 is that the tile can be dynamically resized by changing the size of the window that holds them. Additionally, before the workflows described in FIG. 2 and FIG. 3 are executed, the FX tile display 100 offers users the ability to customize trade parameters. Users can enter a quantity for automatic order or RFQ execution or for ticket population by entering a number into the quantity field 106 shown in FIG. 1. The quantity input field 106 can be controlled by user preferences to default to the quote quantity or a user-defined value (on a per-currency basis). Furthermore, users can change the dealt currency 108 for orders or RFQ's by clicking on the currency abbreviations shown on the “Currency Pair” display 102 of the FX tile of FIG. 1.

While this invention is described in terms of a mouse and “single click” and “double click,” one skilled in the art will appreciate that any input device can serve this function.

When a user double clicks on an execution button 120 in a FX rate tile 100, an attempt is made to automatically submit an order or RFQ. This action follows the workflow shown in FIG. 2. Processing starts in oval 202, where the user double-clicks on an execution button. Processing proceeds to decision diamond 204, where a determination is made whether the rate is currently tradable. If the rate is not currently tradable, the workflow terminates in oval 206. Optionally, an error message is displayed to the user.

If the rate is tradable in decision diamond 204, then a determination is made in decision diamond 208 whether the user has populated the quantity field. If the user has not populated the quantity field with a quantity, then an RFQ ticket is displayed in oval 210, from which a user may place an RFQ.

If the quantity field has been populated (as determined in decision diamond 208), an order or an RFQ is automatically placed on the active dealt currency. The choice of order verses RFQ depends on the status of the rate at the time of the double click. A determination is made in decision diamond 212 whether the rate is firm. If the rate is indicative, then a RFQ is automatically submitted in oval 214. If the rate is firm and the quantity entered is below or equal to the quote size, then an order automatically submitted.

A determination is then made in decision diamond 216 whether the quantity in the quantity field 106 is equal to or less than the quote size. If the quantity is above the quote size, then a RFQ is automatically submitted in oval 214. If the quantity is below or equal to the quote size, then an order is automatically submitted at the quantity in quantity field 106. It is important to re-emphasize that using this single workflow, the new FX trading interface tile 100 uniquely offers harmonized and integrated access to both FX orders and RFQ's.

When a user right clicks on the execution buttons a menu pops up and the above workflow is initiated as shown in FIG. 3. Processing starts in oval 302 when the user right clicks on execution button 120. The user is presented with a pop-up trading menu in action box 204. A determination is made in decision diamond 306 whether the user selected a new order or a new RFQ. If the user selected a new order, then an FX order ticket is displayed in oval 308. If the user selected a new RFQ, then an FX RFQ ticket is displayed in oval 310. While the workflow is very simple—a user can choose to either show an order ticket or an RFQ ticket—it is important to re-emphasize that using this single workflow, the new FX trading interface uniquely offers harmonized and integrated access to both FX orders and RFQ's.

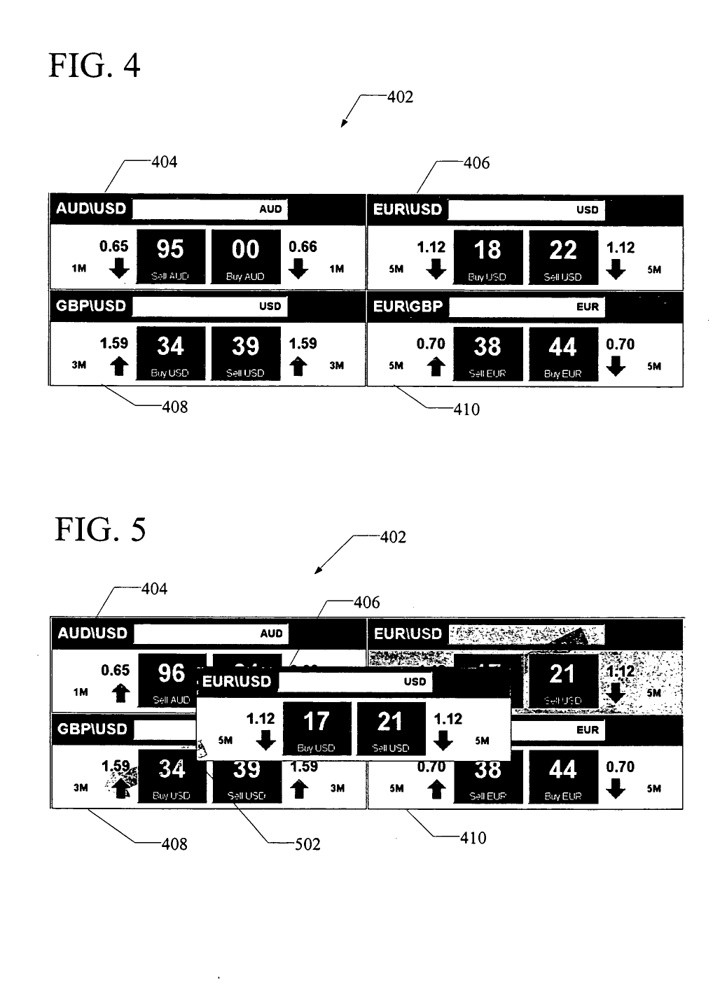

Another unique feature of the FX trading interface is that users can rearrange, resize and “tear off” the individual FX rate tiles can be without loosing the access to order submission or configuration workflows. As illustrated in FIG. 4, FX rate tiles are always initially shown in a window of multiple tiles 402. Window of multiple tiles 402 comprises, in this example, four tiles comprising AUD\USD 404, EUR\USD 406, GBP\USD 408 and EUR\GBP 410. When there are multiple tiles in a window as in FIG. 4, the tiles can be rearranged via a “drag-and-drop” interface.

By clicking on and dragging an individual tile, such as tile 406 dragged along arrow 502, the tiles can be re-arranged in a new order. The other tiles can exchange positions or otherwise have their positions be re-adjusted, as illustrated in FIG. 5.

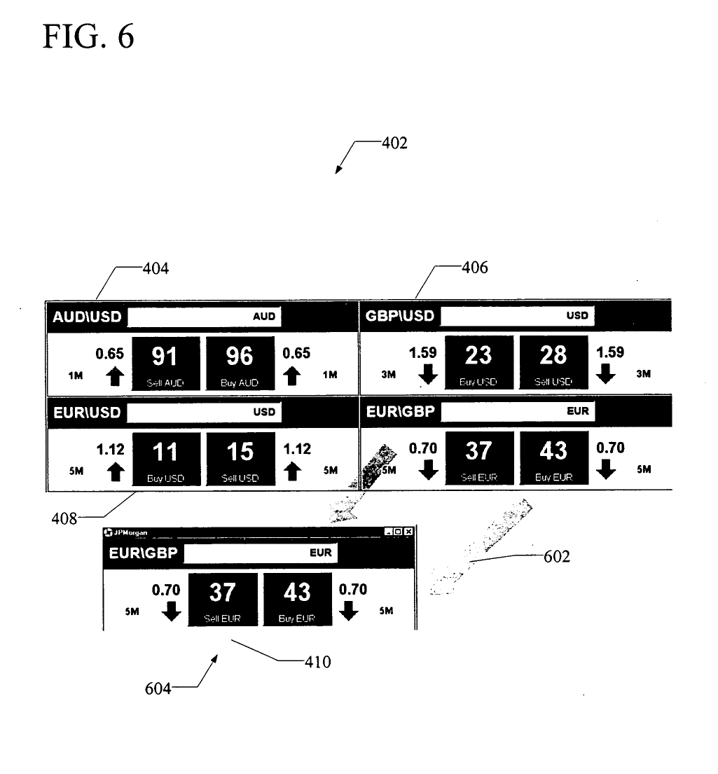

As illustrated in FIG. 6, individual tiles displays can also be “torn-off” to form new, independent windows. A user simply need to drag a tile along lines 602, such as tile 410 out of it container window 402, and the tile 410 will be copied into a new window 604 when the tile 406 is released.

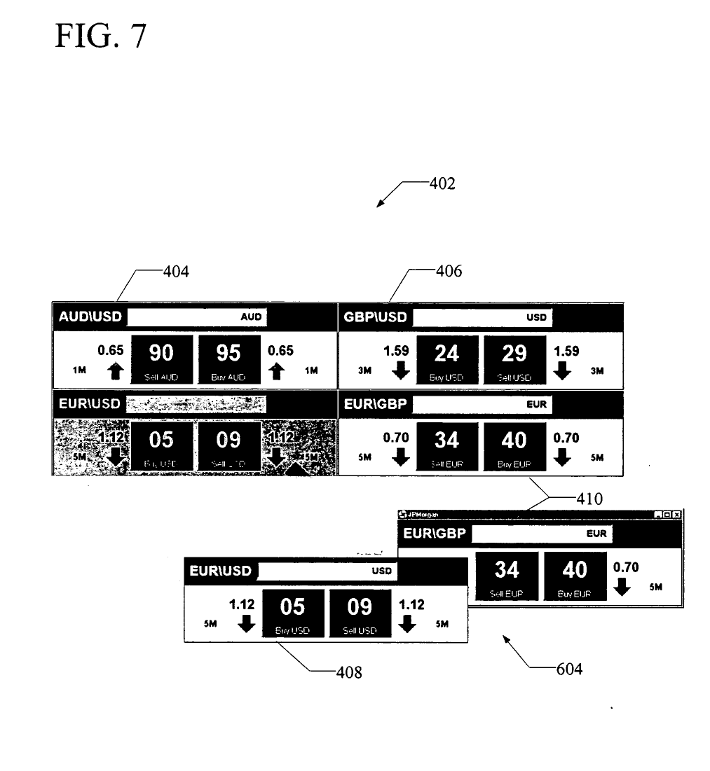

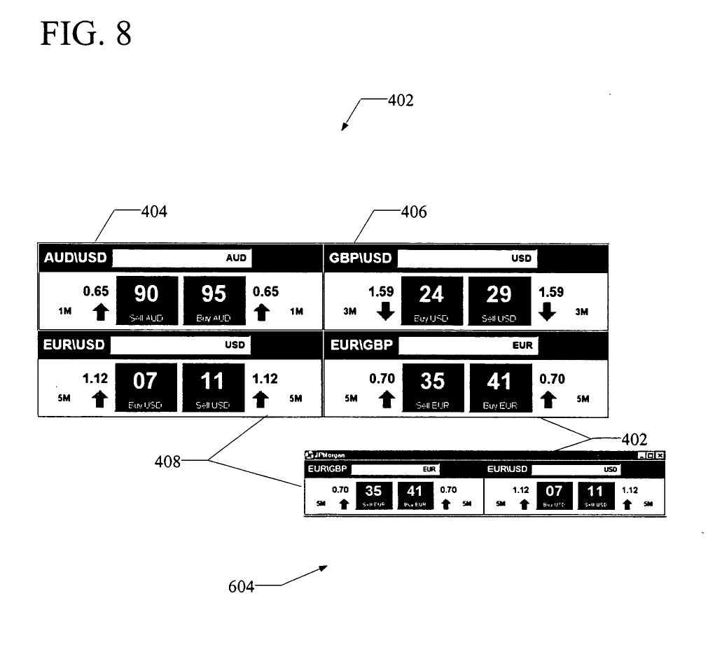

FIGS. 7 and 8 illustrate that individual FX rate tiles can also be combined into new windows. By using the process described above, the user tears off an FX tile, such as 408, from window 402 and releases FX tile 408 while the mouse is over another window 604. If window 604 does not already contain the currency pair, when the mouse is released, the FX tile 408 joins the existing window 604 (instead of creating a new window as in FIG. 5). FIG. 8 illustrates the ending position of all FX tiles.

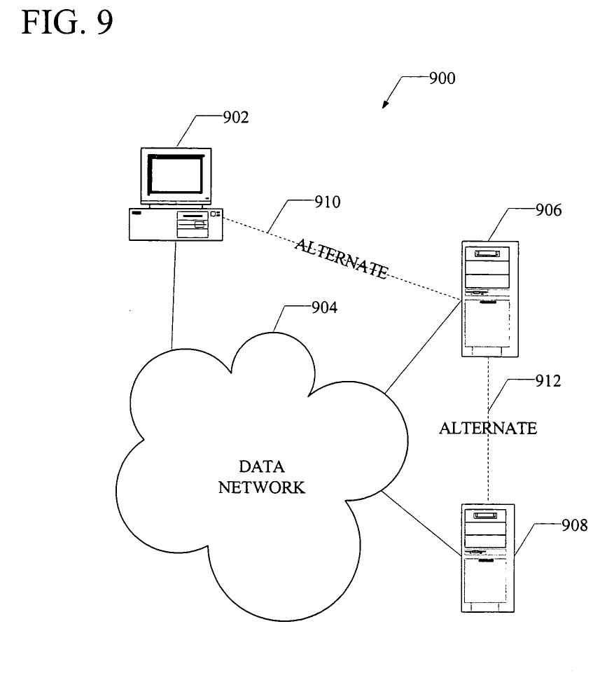

Turning now to FIG. 9, a block diagram 900 is shown of one possible system on which an exemplary embodiment of this invention may be implemented. In this exemplary embodiment, an FX tile is displayed on a personal computer 902. Personal computer 902 is connected via data network 904 to real-time data server 906 and trading server 908. Personal computer 902 receives real-time data updates from data server 906 and updates FX tile accordingly. Personal computer 902 also sends trades and RFQ's to trading server 908. While this invention is described in terms of personal computer 902, other embodiments, such as a work station, a work station connected to a server, etc., will be apparent to one skilled in the art after studying this specification. Further, personal computer 902 may be directly connected to a server 906 via alternate connection 910, which then transacts trades with server 908 via alternate connection 912. Many different configurations of personal computer 902 (or its equivalent), data server 906 and trade server 908 will be apparent to one skilled in the art after studying this specification.

It is to be understood that the above-described embodiment is merely illustrative of the present invention and that many variations of the above-described embodiment can be devised by one skilled in the art without departing from the scope of the invention. It is therefore intended that such variations be included within the scope of the following claims and their equivalents.

1. A method for implementing a trading interface for a user on a computer system having a display, said method comprising:
displaying an icon representative of an instrument for trading;
displaying a quantity of the instrument in the icon;
receiving a stream of purchase information for the instrument and displaying the purchase information stream in the icon;
receiving a sales information stream for the instrument and displaying the sales information stream in the icon;
providing a first location in the icon for the user to indicate a purchase relative to the current display; and
providing a second location in the icon for the user to indicate a sale relative to the current display.

2. A method in accordance with claim 1 wherein displaying said icon comprises displaying a tile.

3. A method in accordance with claim 1 further including:
placing an order for the instrument responsive to the user activating one of the first location in the icon and the second location in the icon.

4. A method in accordance with claim 1 further including:
placing a sell order responsive to the user activating the first location in the icon.

5. A method in accordance with claim 1 further including:
placing a buy order responsive to the user activating the second location in the icon.

6. A method in accordance with claim 1 further including:
providing a third location for the user to enter a quantity.

7. A method in accordance with claim 6 wherein the sales information stream includes a quantity and wherein the method further includes:
the user entering a quantity in the third location;
placing a sell order responsive to the user activating the second location in the icon if the user entered quantity is less than or equal to the sales information stream quantity.

8. A method in accordance with claim 6 wherein the sales information stream includes a quantity and wherein the method further includes:
the user entering a quantity in the third location;
placing a request for quote responsive to the user activating the second location if the user-entered quantity is greater than the sales information stream quantity.

9. A method in accordance with claim 6 wherein the purchase information stream includes a quantity and wherein the method further includes:
the user entering a quantity in the third location;
placing a buy order responsive to the user activating the first location in the icon if the user entered quantity is less than or equal to the sales information stream quantity.

10. A method in accordance with claim 6 wherein the purchase information stream includes a quantity and wherein the method further includes:
the user entering a quantity in the third location;
placing a request for quote responsive to the user activating the first location in the icon if the user entered quantity is greater than the sales information stream quantity.

11. A method in accordance with claim 1 wherein providing a first location in the icon for the user to indicate a purchase comprises providing a first location responsive to a first indicia to execute a purchase and responsive to a second indicia to execute a request for quote.

12. A method in accordance with claim 11 wherein providing a first location responsive to a first indicia comprises providing a first location responsive to an entry indication.

13. A method in accordance with claim 12 wherein said entry indication comprises a left mouse click.

14. A method in accordance with claim 11 wherein providing a first location responsive to a second indicia to execute a request for quote comprises providing a first location responsive to an entry indication.

15. A method in accordance with claim 14 wherein said entry indication comprises a right mouse click.

16. A method in accordance with claim 1 wherein displaying an icon comprises displaying a plurality of icons.

17. A method in accordance with claim 16 wherein displaying a plurality of icons comprises displaying a plurality of icons in a first group.

18. A method in accordance with claim 16 further including:
moving one of said plurality of icons from said first group into a second group.

19. A method in accordance with claim 16 further including:
moving a second one of said plurality of icons from said first group into said second group.

20. A method in accordance with claim 16 further including:
moving more than one of said plurality of icons from said first group into a second group.
